(19) United States
(12) Patent Application Publication
(10) Pub. No.: US 2022/0209935 A1
(43) Pub. Date: Jun. 30, 2022

(54) FILE ENCRYPTION AND DECRYPTION METHOD AND ELECTRONIC DEVICE USING THE SAME

(71) Applicant: HON HAI PRECISION INDUSTRY CO., LTD., New Taipei (TW)

(72) Inventors: LIANG-TE CHIU, New Taipei (TW); WUN-CING LAI, New Taipei (TW)

(21) Appl. No.: 17/555,421

(22) Filed: Dec. 18, 2021

(30) Foreign Application Priority Data
Dec. 28, 2020 (CN) 202011585215.6

(51) Int. Cl. H04L 9/06; H04L 9/30

(52) U.S. Cl. CPC H04L 9/0618; H04L 9/0643; H04L 9/30

(57) ABSTRACT

A file encryption and decryption method used in an electronic device generates a symmetric key and asymmetric keys, according to the number of sharers who are to receive the file. The asymmetric keys comprise public and private keys. An original file is encrypted by the symmetric key to generate a first encrypted file, encrypt the symmetric key with the public key to generate a first ciphertext, calculates an MD5 value of the original file, and calculates a first total length of the MD5 value, the public key, and the first ciphertext. The first total length is taken as a header file of the first encrypted file, the header file, the public key, and the first ciphertext are added to the first encrypted file to generate a second encrypted file, the procedure being repeated for each of the number of sharers.

### CROSS-REFERENCE TO RELATED APPLICATIONS

This application claims priority to Chinese Patent Application No. 202011585215.6 filed on Dec. 28, 2020, the contents of which are incorporated by reference herein.

### FIELD

The subject matter herein generally relates to a field of data security, and especially relates to a file encryption and decryption method and an electronic device.

### BACKGROUND

Current file encryption method usually encrypts files by one symmetric key or two asymmetric keys. The above described methods require use of a specific and unique key to decrypt, multiple attempts to decrypt the document by using the same key are allowed, thereby reducing a security of the files. Furthermore, to prevent a third party from having the same key, it is necessary to use another key to encrypt a file, which may be inconvenient.

### BRIEF DESCRIPTION OF THE DRAWINGS

Implementations of the present disclosure will now be described, by way of embodiment, with reference to the attached figures.

FIG. 1 is a flowchart of one embodiment of a file encryption and decryption method according to the present disclosure.

FIG. 2 is a block diagram of one embodiment of a file encryption and decryption device according to the present disclosure.

FIG. 3 is a schematic diagram of one embodiment of an electronic device according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

A file encryption and decryption method is illustrated in the disclosure. The method is applied in one or more electronic devices. The electronic can automatically perform numerical calculation and/or information processing according to a number of preset or stored instructions. The hardware of the electronic device includes, but is not limited to, a microprocessor, an Application Specific Integrated Circuit (ASIC), a Field Programmable Gate Array (FPGA), a Digital signal processor (DSP), or an embedded equipment, etc.

In one embodiment, the electronic device can be a desktop computer, a notebook computer, a tablet computer, a cloud server, or other computing device. The device can carry out a human-computer interaction with user by a keyboard, a mouse, a remote controller, a touch pad or a voice control device.

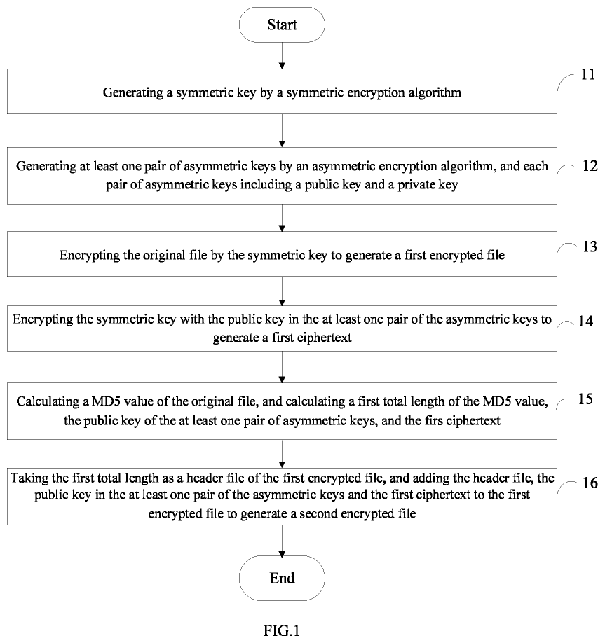

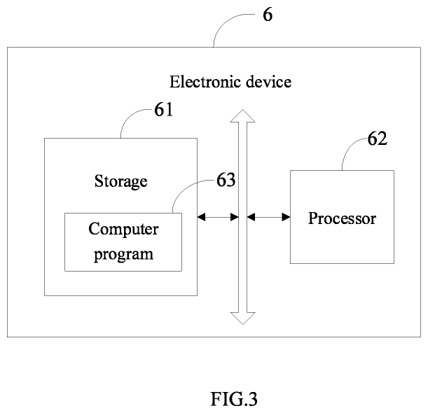

FIG. 1 illustrates the file encryption and decryption method. The method is applied in the electronic device 6 (referring to FIG. 3). The method is provided by way of example, as there are a variety of ways to carry out the method. Each block shown in FIG. 1 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 11.

At block 11, generating a symmetric key by a symmetric encryption algorithm.

In one embodiment, the symmetric key is generated by the symmetric encryption algorithm, and a file can be encrypted by the symmetric key to obtain an encrypted original file, or an encrypted original file can be decrypted by the symmetric key to obtain the original file. In one embodiment, the symmetric encryption algorithm includes, but is not limited to a Data Encryption Standard (DES) algorithm, a Data Triple Encryption Standard (TDEA) algorithm, a blowfish algorithm, or an RC5 algorithm.

At block 12, generating at least one pair of asymmetric keys by an asymmetric encryption algorithm, and each pair of asymmetric keys including a public key and a private key.

In one embodiment, the at least one pair of asymmetric keys is generated by the asymmetric encryption algorithm, where the public key in the at least one pair of asymmetric keys is used to encrypt an original file, and the private key in the at least one pair of asymmetric keys is used to decrypt the original file. In one embodiment, the asymmetric key algorithm includes, but is not limited to, a Rivest-Shamir-Adleman (RSA) algorithm, an elganal algorithm, a knapsack algorithm, a Rabin algorithm, a Diffie-Hellman (D-H) algorithm, and elliptic curve encryption algorithm.

In one embodiment, generating at least one pair of asymmetric keys by an asymmetric encryption algorithm includes: determining a number of the asymmetric keys according to a shared number of the original files. For example, when original files need to be distributed to three users: users A, B, and C, the number of the asymmetric keys will be three according to number of versions of the original files to be shared. The three asymmetric keys are generated by the asymmetric encryption algorithm, where, the private key in each pair of the asymmetric keys in the three pairs is allocated to user A, user B and user C respectively, so that user A, user B, and user C can decrypt the file encrypted by the public key according to the allocated private key.

At block 13, encrypting the original file by the symmetric key to generate a first encrypted file.

At block 14, encrypting the symmetric key with the public key in the at least one pair of the asymmetric keys to generate a first ciphertext.

At block 15, calculating an MD5 value of the original file, and calculating a first total length of the MD5 value, the public key of the at least one pair of asymmetric keys, and the first ciphertext.

At block 16, taking the first total length as a header file of the first encrypted file, adding the header file, the public key in the at least one pair of the asymmetric keys, and the first ciphertext to the first encrypted file, to generate a second encrypted file.

In one embodiment, the method further includes: decrypting the second encrypted file by the private key in each pair of the asymmetric keys of the at least one pair of asymmetric keys to obtain the symmetric key and the first encrypted file; and decrypting the first encrypted document with the symmetric key to obtain the original file.

In one embodiment, decrypting the second encrypted file by the private key in each pair of the asymmetric keys of the at least one pair of asymmetric keys to obtain the symmetric key includes: decrypting a ciphertext corresponding to each pair of the asymmetric keys in the header file by the private key in each pair of the asymmetric keys of the at least one pair of asymmetric keys to obtain the symmetric key. In one embodiment, the ciphertext corresponding to each pair of the asymmetric keys is generated by encrypting the symmetric key by the public key in each pair of the asymmetric keys.

In one embodiment, the method further includes: receiving an instruction to add one or more pairs of the asymmetric keys; adding one or more pairs of newly added asymmetric keys according to the instruction; encrypting the symmetric key with the public key in the newly added asymmetric key to generate a second ciphertext; calculating a second total length of the MD5 value, the public key of the at least one pair of the asymmetric keys, the newly added asymmetric key, the first ciphertext, and the second ciphertext. The second total length is taken as the header file of the second encrypted file, and adding the header file of the second encrypted file, the public key in the at least one pair of the asymmetric keys, the public key in the newly asymmetric key, and the first ciphertext and the second ciphertext to the first encrypted file, to generate a third encrypted file.

In one embodiment, the method further includes: decrypting the third encrypted file by the private key in each pair of the asymmetric keys of the at least one pair of asymmetric keys or the private key in the newly asymmetric key to obtain the symmetric key and the first encrypted file; and decrypting the first encrypted file with the symmetric key to obtain the original file.

In one embodiment, when there are three persons to share the asymmetric keys, the three asymmetric keys will be the first pair of the asymmetric keys, the second pair of the asymmetric keys, and the third pair of the asymmetric keys respectively. The electronic device 6 encrypts the symmetric key with the public key in the first pair of the asymmetric keys to generate a first sub-ciphertext, encrypts the symmetric key with the public key in the second pair of the asymmetric keys to generate a second sub-ciphertext, and encrypts the symmetric key with the public key in the third pair of the asymmetric keys to generate a third sub-ciphertext. The first total length of the MD5 value is calculated, together with the public key in the first pair of the asymmetric keys, the public key in the second pair of the asymmetric keys, the public key in the third pair of the asymmetric keys, the first sub-ciphertext, the second sub-ciphertext and the third sub ciphertext. The first total length is taken as the header file of the first encrypted file, and the header file, the public key in the first pair of the asymmetric keys, the public key in the second pair of the asymmetric keys, the public key in the third pair of the asymmetric keys, the first sub-ciphertext, the second sub-ciphertext and the third sub-ciphertext are added to the first encrypted file to generate the second encrypted file.

The present disclosure generates the second encrypted file by taking the MD5 value of the original file, the public key of at least one pair of asymmetric keys and the first ciphertext as the header file of the first encrypted file, and adding the header file, the public key of at least one pair of asymmetric keys and the first ciphertext to the first encrypted file to generate the second ciphertext, thus avoiding reduction of security of the file when decrypting the file with the same key, and avoids an inconvenience caused by re encrypting the file.

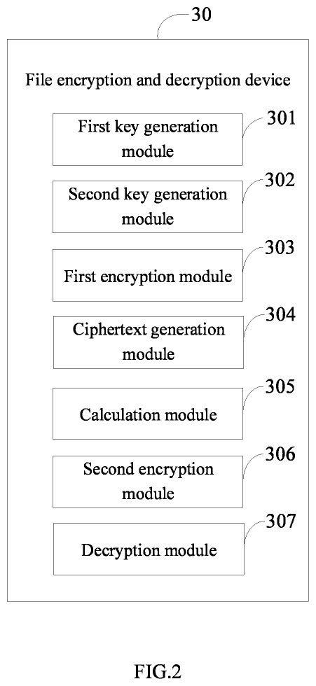

FIG. 2 illustrates a file encryption and decryption device 30. The file encryption and decryption device 30 is applied in the electronic device 6. In one embodiment, according to the functions it performs, the file encryption and decryption device 30 can be divided into a plurality of functional modules. The functional modules perform the blocks 11-16 in the embodiment of FIG. 1 to perform the functions of file encryption and decryption.

In one embodiment, the file encryption and decryption device 30 includes, but is not limited to, a first key generation module 301, a second key generation module 302, a first encryption module 303, a ciphertext generation module 304, a calculation module 305, a second encryption module 306 and a decryption module 307. The modules 301-307 of the file encryption and decryption device 30 can be collections of software instructions. In one embodiment, the program code of each program segment in the software instructions can be stored in a storage and executed by at least one processor to perform the function of file encryption and decryption.

The first key generation module 301 generates a symmetric key by a symmetric encryption algorithm.

In one embodiment, the symmetric key is generated by the symmetric encryption algorithm, and the original file is encrypted by the symmetric key to obtain an original encrypted file, or the original encrypted file is decrypted by the symmetric key to obtain the original file. In one embodiment, the symmetric encryption algorithm includes, but is not limited to, a Data Encryption Standard (DES) algorithm, a Data Triple Encryption Standard (TDEA) algorithm, a blowfish algorithm, or an RC5 algorithm.

The second key generation module 302 generates at least one pair of asymmetric keys by an asymmetric encryption algorithm, and each pair of asymmetric keys includes a public key and a private key.

In one embodiment, the at least one pair of asymmetric keys is generated by the asymmetric encryption algorithm, where the public key in the at least one pair of asymmetric keys is used to encrypt the original file, and the private key in the at least one pair of asymmetric keys is used to decrypt the original encrypted file. In one embodiment, the asymmetric key algorithm includes, but is not limited to, a Rivest-Shamir-Adleman (RSA) algorithm, an elganal algorithm, a knapsack algorithm, a Rabin algorithm, a Diffie-Hellman (D-H) algorithm, and elliptic curve encryption algorithm.

In one embodiment, the second key generation module 302 determines a number of the asymmetric keys according to a shared number of the original files. For example, when the original files need to be distributed to three users: user A, user B, and user C, the number of the asymmetric keys are determined to be three according to three sharers of the original files, the three asymmetric keys are generated by the asymmetric encryption algorithm, where, the private key in each pair of the asymmetric keys in the three pairs is allocated to user A, user B and user C respectively, so that user A, user B and user C decrypt the file encrypted by the public key according to the allocated private key.

The first encryption module 303 encrypts the original file by the symmetric key to generate a first encrypted file.

The ciphertext generation module 304 encrypts the symmetric key with the public key in the at least one pair of the asymmetric keys to generate a first ciphertext.

The calculation module 305 calculates an MD5 value of the original file, and calculates a first total length of the MD5 value, the public key of the at least one pair of asymmetric keys, and the first ciphertext.

The second encryption module 306 takes the first total length as a header file of the first encrypted file, and adds the header file, the public key in the at least one pair of the asymmetric keys, and the first ciphertext to the first encrypted file to generate a second encrypted file.

In one embodiment, the decryption module 307 decrypts the second encrypted file by the private key in each pair of the asymmetric keys of the at least one pair of asymmetric keys to obtain the symmetric key and the first encrypted file, and decrypts the first encrypted document with the symmetric key to obtain the original file.

In one embodiment, the decryption module 307 decrypts a ciphertext corresponding to each pair of the asymmetric keys in the header file by the private key in each pair of the asymmetric keys of the at least one pair of asymmetric keys to obtain the symmetric key. In one embodiment, the ciphertext corresponding to each pair of the asymmetric keys is generated by encrypting the symmetric key by the public key in each pair of the asymmetric keys.

In one embodiment, the second key generation module 302 receives an instruction to add one or more pairs of the asymmetric keys, adds one or more pairs of newly added asymmetric keys according to the instruction, encrypts the symmetric key with the public key in the newly added asymmetric key to generate a second ciphertext, calculates a second total length of the MD5 value, the public key of the at least one pair of the asymmetric keys, the newly added asymmetric key, the first ciphertext and the second ciphertext, and takes the second total length as the header file of the second encrypted file, and adds the header file of the second encrypted file, the public key in the at least one pair of the asymmetric keys, the public key in the newly asymmetric key, and the first ciphertext and the second ciphertext to the first encrypted file, to generate a third encrypted file.

In one embodiment, the decryption module 307 decrypts the third encrypted file by the private key in each pair of the asymmetric keys of the at least one pair of asymmetric keys or the private key in the newly asymmetric key to obtain the symmetric key and the first encrypted file, and decrypts the first encrypted file with the symmetric key to obtain the original file.

In one embodiment, the second key generation module 302 determines the number of the asymmetric keys to be three according to the number of sharers of the original files, the three asymmetric keys are the first pair of the asymmetric keys, the second pair of the asymmetric keys and the third pair of the asymmetric keys respectively. The ciphertext generation module 304 encrypts the symmetric key with the public key in the first pair of the asymmetric keys to generate a first sub-ciphertext, encrypts the symmetric key with the public key in the second pair of the asymmetric keys to generate a second sub-ciphertext, encrypts the symmetric key with the public key in the third pair of the asymmetric keys to generate a third sub-ciphertext. The calculation module 305 calculates the first total length of the MD5 value, the public key in the first pair of the asymmetric keys, the public key in the second pair of the asymmetric keys, the public key in the third pair of the asymmetric keys, the first sub-ciphertext, the second sub-ciphertext and the third sub ciphertext. The second encryption module 306 takes the first total length as the header file of the first encrypted file, and adds the header file, the public key in the first pair of the asymmetric keys, the public key in the second pair of the asymmetric keys, the public key in the third pair of the asymmetric keys, the first sub-ciphertext, the second sub-ciphertext and the third sub-ciphertext to the first encrypted file, to generate the second encrypted file.

The present disclosure generates the second encrypted file by taking the MD5 value of the original file, the public key of at least one pair of asymmetric keys, and the first ciphertext as the header file of the first encrypted file, and adds the header file, the public key of at least one pair of asymmetric keys, and the first ciphertext to the first encrypted file to generate the second ciphertext, thus avoiding a problem of reducing security of the file when decrypting the file with the same key, and avoids an inconvenience caused by re-encrypting the file.

FIG. 3 illustrates the electronic device 6. The electronic device 6 includes a storage 61, a processor 62, and a computer program 63 stored in the storage 61 and executed by the processor 62. When the processor 62 executes the computer program 63, the blocks in the embodiment of the file encryption and decryption method are implemented, for example, blocks 11 to 16 as shown in FIG. 1. Alternatively, when the processor 62 executes the computer program 63, the functions of the modules in the embodiment of the file encryption and decryption device are implemented, for example, modules 301-307 shown in FIG. 2.

In one embodiment, the computer program 63 can be partitioned into one or more modules/units that are stored in the storage 61 and executed by the processor 62. The one or more modules/units may be a series of computer program instruction segments capable of performing a particular function, and the instruction segments describe the execution of the computer program 63 in the electronic device 6. For example, the computer program 63 can be divided into the first key generation module 301, the second key generation module 302, the first encryption module 303, the ciphertext generation module 304, the calculation module 305, the second encryption module 306, and the decryption module 307 as shown in FIG. 2.

FIG. 3 shows only one example of the electronic device 6. There are no limitations of the electronic device 6, and other examples may include more or less components than those illustrated, or some components may be combined, or have a different arrangement. The components of the electronic device 6 may also include input devices, output devices, communication units, network access devices, buses, and the like.

The processor 62 can be a central processing unit (CPU), and also include other general-purpose processors, a digital signal processor (DSP), and application specific integrated circuit (ASIC), Field-Programmable Gate Array (FPGA) or other programmable logic device, discrete gate or transistor logic device, discrete hardware components, etc. The processor 62 may be a microprocessor or the processor may be any conventional processor or the like. The processor 62 is the control center of the electronic device 6, and connects the electronic device 6 by using various interfaces and lines. The storage 61 can be used to store the computer program 63, modules or units, and the processor 62 can realize various functions of the electronic device 6 by running or executing the computer program, modules or units stored in the storage 61 and calling up the data stored in the storage 61.

In one embodiment, the storage 61 may include a program storage area and a data storage area, wherein the program storage area may store an operating system, an application program (such as a sound playback function, an image playing function, etc.) required for at least one function, etc. The data storage area can store data (such as audio data, telephone book, etc.) created according to the use of electronic device 6. In addition, the storage 61 may include a high-speed random access memory, and may also include a non-volatile memory, such as a hard disk, an internal memory, a plug-in hard disk, a smart media card (SMC), a secure digital (SD) card, a flash card, at least one disk storage device, a flash memory device, or other volatile solid state storage device.

In one embodiment, the modules/units integrated in the electronic device 6 can be stored in a computer readable storage medium if such modules/units are implemented in the form of a product. Thus, the present disclosure may be implemented and realized in any part of the method of the foregoing embodiments, or may be implemented by the computer program, which may be stored in the computer readable storage medium. The steps of the various method embodiments described above may be implemented by a computer program when executed by a processor. The computer program includes computer program code, which may be in the form of source code, object code form, executable file, or some intermediate form. The computer readable medium may include any entity or device capable of carrying the computer program code, a recording medium, a USB flash drive, a removable hard disk, a magnetic disk, an optical disk, a computer memory, a read-only memory (ROM), random access memory (RAM), electrical carrier signals, telecommunication signals, and software distribution media.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A file encryption and decryption method comprising:
generating a symmetric key by a symmetric encryption algorithm;
generating at least one pair of asymmetric keys by an asymmetric encryption algorithm, and each pair of asymmetric keys comprising a public key and a private key;
encrypting an original file by the symmetric key to generate a first encrypted file;
encrypting the symmetric key with the public key in the at least one pair of the asymmetric keys to generate a first ciphertext;
calculating a MD5 value of the original file, and calculating a first total length of the MD5 value, the public key of the at least one pair of asymmetric keys, and the first ciphertext;
taking the first total length as a header file of the first encrypted file, and adding the header file, the public key in the at least one pair of the asymmetric keys and the first ciphertext to the first encrypted file to generate a second encrypted file.

2. The file encryption and decryption method as recited in claim 1, further comprising:
decrypting the second encrypted filet by the private key in each pair of the asymmetric keys of the at least one pair of asymmetric keys to obtain the symmetric key and the first encrypted file; and
decrypting the first encrypted document with the symmetric key to obtain the original file.

3. The file encryption and decryption method as recited in claim 2, further comprising:
decrypting a ciphertext corresponding to each pair of the asymmetric keys in the header file by the private key in each pair of the asymmetric keys of the at least one pair of asymmetric keys to obtain the symmetric key.

4. The file encryption and decryption method as recited in claim 1, further comprising:
determining a number of the asymmetric keys according to a shared number of the original files.

5. The file encryption and decryption method as recited in claim 1, further comprising:
receiving an instruction to add one or more pairs of the asymmetric keys;
adding one or more pairs of newly added asymmetric keys according to the instruction;
encrypting the symmetric key with the public key in the newly added asymmetric key to generate a second ciphertext;
calculating a second total length of the MD5 value, the public key of the at least one pair of the asymmetric keys, the newly added asymmetric key, the first ciphertext and the second ciphertext;
taking the second total length as the header file of the second encrypted file; and
adding the header file of the second encrypted file, the public key in the at least one pair of the asymmetric keys, the public key in the newly asymmetric key, and the first ciphertext and the second ciphertext to the first encrypted file to generate a third encrypted file.

6. The file encryption and decryption method as recited in claim 5, further comprising:
decrypting the third encrypted file by the private key in each pair of the asymmetric keys of the at least one pair of asymmetric keys or the private key in the newly asymmetric key to obtain the symmetric key and the first encrypted file; and
decrypting the first encrypted file with the symmetric key to obtain the original file.

7. An electronic device comprising:
a processor; and
a non-transitory storage medium coupled to the processor and configured to store a plurality of instructions, which cause the processor to:
generate a symmetric key by a symmetric encryption algorithm;
generate at least one pair of asymmetric keys by an asymmetric encryption algorithm, and each pair of asymmetric keys comprise a public key and a private key;
encrypt an original file by the symmetric key to generate a first encrypted file;
encrypt the symmetric key with the public key in the at least one pair of the asymmetric keys to generate a first ciphertext;
calculate a MD5 value of the original file, and calculate a first total length of the MD5 value, the public key of the at least one pair of asymmetric keys, and the first ciphertext;
take the first total length as a header file of the first encrypted file, and add the header file, the public key in the at least one pair of the asymmetric keys and the first ciphertext to the first encrypted file to generate a second encrypted file.

8. The electronic device as recited in claim 7, wherein the plurality of instructions are further configured to cause the processor to:
decrypt the second encrypted filet by the private key in each pair of the asymmetric keys of the at least one pair of asymmetric keys to obtain the symmetric key and the first encrypted file; and
decrypt the first encrypted document with the symmetric key to obtain the original file.

9. The electronic device as recited in claim 8, wherein the plurality of instructions are further configured to cause the processor to:
decrypt a ciphertext corresponding to each pair of the asymmetric keys in the header file by the private key in each pair of the asymmetric keys of the at least one pair of asymmetric keys to obtain the symmetric key.

10. The electronic device as recited in claim 7, wherein the plurality of instructions are further configured to cause the processor to:
determine a number of the asymmetric keys according to a shared number of the original files.

11. The electronic device as recited in claim 7, wherein the plurality of instructions are further configured to cause the processor to:
receive an instruction to add one or more pairs of the asymmetric keys;
add one or more pairs of newly added asymmetric keys according to the instruction;
encrypt the symmetric key with the public key in the newly added asymmetric key to generate a second ciphertext;
calculate a second total length of the MD5 value, the public key of the at least one pair of the asymmetric keys, the newly added asymmetric key, the first ciphertext and the second ciphertext;
take the second total length as the header file of the second encrypted file; and
add the header file of the second encrypted file, the public key in the at least one pair of the asymmetric keys, the public key in the newly asymmetric key, and the first ciphertext and the second ciphertext to the first encrypted file to generate a third encrypted file.

12. The electronic device as recited in claim 11, wherein the plurality of instructions are further configured to cause the processor to:
decrypt the third encrypted file by the private key in each pair of the asymmetric keys of the at least one pair of asymmetric keys or the private key in the newly asymmetric key to obtain the symmetric key and the first encrypted file; and
decrypt the first encrypted file with the symmetric key to obtain the original file.

13. A non-transitory storage medium having stored thereon instructions that, when executed by at least one processor of an electronic device, causes the least one processor to execute instructions of a file encryption and decryption method, the method comprising:
generating a symmetric key by a symmetric encryption algorithm;
generating at least one pair of asymmetric keys by an asymmetric encryption algorithm, and each pair of asymmetric keys comprising a public key and a private key;
encrypting an original file by the symmetric key to generate a first encrypted file;
encrypting the symmetric key with the public key in the at least one pair of the asymmetric keys to generate a first ciphertext;
calculating a MD5 value of the original file, and calculating a first total length of the MD5 value, the public key of the at least one pair of asymmetric keys, and the first ciphertext;
taking the first total length as a header file of the first encrypted file, and adding the header file, the public key in the at least one pair of the asymmetric keys and the first ciphertext to the first encrypted file to generate a second encrypted file.

14. The non-transitory storage medium as recited in claim 13, wherein the file encryption and decryption method comprising:
decrypting the second encrypted filet by the private key in each pair of the asymmetric keys of the at least one pair of asymmetric keys to obtain the symmetric key and the first encrypted file; and
decrypting the first encrypted document with the symmetric key to obtain the original file.

15. The non-transitory storage medium as recited in claim 14, wherein the file encryption and decryption method comprising:
decrypting a ciphertext corresponding to each pair of the asymmetric keys in the header file by the private key in each pair of the asymmetric keys of the at least one pair of asymmetric keys to obtain the symmetric key.

16. The non-transitory storage medium as recited in claim 13, wherein the file encryption and decryption method comprising:
determining a number of the asymmetric keys according to a shared number of the original files.

17. The non-transitory storage medium as recited in claim 13, wherein the file encryption and decryption method comprising:
receiving an instruction to add one or more pairs of the asymmetric keys;
adding one or more pairs of newly added asymmetric keys according to the instruction;
encrypting the symmetric key with the public key in the newly added asymmetric key to generate a second ciphertext;
calculating a second total length of the MD5 value, the public key of the at least one pair of the asymmetric keys, the newly added asymmetric key, the first ciphertext and the second ciphertext;
taking the second total length as the header file of the second encrypted file; and
adding the header file of the second encrypted file, the public key in the at least one pair of the asymmetric keys, the public key in the newly asymmetric key, and the first ciphertext and the second ciphertext to the first encrypted file to generate a third encrypted file.

18. The non-transitory storage medium as recited in claim 17, wherein the file encryption and decryption method comprising:
decrypting the third encrypted file by the private key in each pair of the asymmetric keys of the at least one pair of asymmetric keys or the private key in the newly asymmetric key to obtain the symmetric key and the first encrypted file; and
decrypting the first encrypted file with the symmetric key to obtain the original file.
